(19) United States
(12) Patent Application Publication
(10) Pub. No.: US 2026/0158302 A1
(43) Pub. Date: Jun. 11, 2026

(54) DUAL CHAMBERED PROTECTIVE MASK AND FRAME INSERT FOR FORMING THE SAME

(71) Applicant: RODAN ENTERPRISES, LLC, Doylestown, PA (US)

(72) Inventor: RONALD K. RUSSIKOFF, PHILADELPHIA, PA (US)

(73) Assignee: RODAN ENTERPRISES, LLC, Doylestown, PA (US)

(21) Appl. No.: 18/445,804

(22) PCT Filed: Jan. 31, 2022
(86) PCT No.: PCT/US2022/000004

§ 371 Date: Feb. 9, 2024

Related U.S. Application Data
(60) Provisional application No. 63/360,142, filed on Sep. 8, 2021.

(51) Int. Cl. A62B 18/02; A41D 13/11; A62B 9/04

(52) U.S. Cl. CPC A62B 18/025; A41D 13/1107; A62B 9/04

(57) ABSTRACT

A frame insert is disclosed for use in support of a conventional protective face mask covering forming a conventional single chamber over the nose and mouth of the wearer wherein the frame insert is specially formed and configured to engage the surface coverings of the single chamber mask in a releasable attachment and provide separate isolated chambers about the nose and mouth regions with distinct air flow passages for healthier breathing by the wearer. In one aspect of the invention, the frame insert is integrally formed in a triangular shape comprising a first edge, a second edge and a curved base strut therebetween along the perimeter, the first edge and the second edge converging to meet at a vertex forwardmost on the frame insert and the base strut extending in a arcuate configuration between separate ends of the first edge and second edge rearward on the frame insert. In another aspect of the invention, the frame insert is integrally formed in a trapezoidal shape with the first edge and the second edge being joined with an intermediate edge forwardmost on the perimeter of the frame insert. Interstitial slots formed along the perimeter lengths of the first and second edge provide sliding engagement of the frame insert with the surface coverings of the mask allowing proper positioning of the frame insert within the mask with reduced leakage gaps therebetween.

### CROSS-REFERENCE TO RELATED APPLICATION

This application claims the benefit of U.S. Provisional Application Ser. No. 63/360,142 filed on Sep. 8, 2021 for Dual Chambered Protective Mask and Frame Insert for Forming the Same.

### FIELD OF THE INVENTION

The present disclosure relates to attachments for a face mask covering used to protect a wearer against exposure to airborne germs and pollutants, and more particularly, to an improved frame insert intended to support a conventional protective mask covering of the type having a single chamber over the nose and mouth of the wearer, wherein the frame insert is configured to engage the surface coverings of the single chamber mask in a releasable attachment and thereby provide separate isolated chambers about the nose and mouth regions with distinct air flow passages for healthier breathing by the wearer while maintaining protection.

### BACKGROUND OF THE INVENTION

A protective face mask creates a physical barrier covering the nose and mouth of the wearer. The face mask generally includes a mask body with ear loops that fit upon the ears of the wearer. When worn properly, the face mask prevents the wearer from germs (viruses and bacteria) by blocking the passage of liquid droplets, splashes, splatter, sprays and aerosols, contained in the air flowing into the user's nose and mouth. While a substantial majority of the face masks made and worn in practice today are those of the type wherein the mask body establishes a single unitized chamber about the wearer's nose and mouth, there are difficulties experienced by many users with wearing these single chamber masks, particularly over long periods of time, and significant benefits in establishing separate isolated chambers between the nose and mouth within a dual chambered mask body that better directs the flow of breathing air within the mask and reduces the re-inhalation of exhaled air by the wearer.

Another problem commonly found with the conventional single chamber mask body is the nature of its fit upon the face of the wearer, a fit while designed to be somewhat flexible, generally remains uncomfortably close in contact with the wearer's face, leading to skin irritation and further restricting the ability of the wearer to speak and converse in a clear and intelligible fashion. Certain prior art mask frame supports have been designed and developed in structural forms that may be integrated into the single chamber mask body or produced as separate members that may be worn upon the face beneath the mask to deepen the chamber and provide additional space between the mouth and the mask for better breathing and talking without irritating the skin. This group of prior art mask frame supports, particularly the separate structural forms found in a variety of cup-shaped configurations designed to clip to the supported mask, while making the associated single chamber mask body more comfortable to wear, still present limitations in their ability to control the air flow within the supported mask and isolate air inhaled and exhaled by the nose and mouth to enable the wearer to have sufficient clean air for breathing. Even those prior art mask supports that incorporate a level of separation between the nose and mouth are found lacking due to spatial gaps that form between the frame support and the supported mask when attached together that allow leakage of exhaled air from the mouth area to the nose area. These leakage gaps in the attachment of these prior art frame supports and the resulting bleeding of exchanged air from the mouth to the nose chamber will adversely affect the ability of the wearer to inhale clean oxygen and exhale carbon dioxide while wearing the supported mask over extended periods of time.

Therefore, there is a need for an improved face mask support frame that will effectively assemble to and transform a conventional single chamber protective face mask to a dual-chambered face mask with separate and isolated nose and mouth chambers being formed for healthier breathing in a comfortable-to-wear protective assembly without any leakage gaps between the support frame and the mask covering.

### SUMMARY OF THE INVENTION

Accordingly, it is a general purpose and object of the present invention to provide an improved method of making a dual-chambered protective face mask having separate and isolated breathing chambers formed about the nose and mouth of the wearer for greater comfort and healthier breathing during prolonged periods of usage.

A more particular object of the present invention is to provide a support frame member adapted for an assembled engagement in combination with a conventional single chamber protective face mask that will transform the single chamber face mask to a dual-chambered mask with separate and isolated breathing chambers over the nose and mouth of the wearer without leakage gaps therebetween and provide an effective barrier against air pollutants and germs while enabling the wearer to better breathe clean air during prolonged periods of usage.

Another object of the present invention is to provide a universal support frame that may be releasably attached to the mask body of a variety of different available types and sizes of single chamber protective face masks in each instance producing a dual-chambered protective face mask with separate isolated chambers established over the nose and mouth of the wearer for better comfort and breathing while worn.

Still another object of the present invention is to provide a specially formed and configured support frame that when assembled in engagement with any type or size of available single chamber protective face mask will provide a secure and comfortable dual-chambered mask for protection of the wearer with healthier directional air flow during the normal process of breathing.

A still further object of the present invention is to provide a comfortable and effective dual-chambered protective face mask that is easily assembled and made from component parts that are relatively inexpensive to manufacture and readily available.

Briefly, these and other objects of the present invention are accomplished by a specially-configured frame insert for transforming a single-chambered mask into a protective dual-chambered mask, with the frame insert dividing the single chamber mask upon engaged assembly into an isolated two-chamber mask for healthier breathing and eliminate leakage gaps between the mask and the frame insert. In one aspect of the present invention, the frame insert is integrally formed in a triangular shape comprising a first edge, a second edge and a curved base strut extending together along the perimeter. The first edge and the second edge converge about a panel section forwardly to meet at a vertex at the front of the frame insert with the curved strut extending in an arcuate configuration between separate ends of the first edge and second edge to create a base opening distal to the forward vertex. In a preferred embodiment, interstitial slots are formed along the perimeter lengths of the first and second edge to provide sliding engagement of the frame insert with the surface coverings of the mask and allow for proper positioning of the frame insert within the mask with reduced leakage gaps therebetween. In an alternate embodiment, clip-like members are formed at selected positions rearward on either side of the first and the second edge that serve to engage the covering of the mask, whether that of a surgical mask or that of an N95, and provide means for engaging lateral edges of the mask and holding the mask covering in tension so as to keep the covering close in contact with the frame insert when assembled.

In another preferred embodiment of the present invention, the frame insert is integrally formed in a trapezoidal shape with the first edge and the second edge being interconnected with an intermediate edge together joined about a trapezoidal panel section forwardmost on the frame insert, providing a forward surface more compatible with wider width masks such as that of the N95. In this embodiment, interstitial slots are formed along the entire perimeter lengths of the first, second and intermediate edges for fully engaging the mask covering with the frame insert properly positioned within the mask with reduced leakage gaps therebetween.

In yet another aspect of the present invention, the frame insert assembles in combination with a conventional single-chambered mask body having an outer surface and an inner surface covering at least the nose and mouth and a pair of ear loops disposed on the mask body to produce a dual-chambered mask more beneficial to the wearer. The frame insert is formed and configured to act as a separation means which substantially dividing the inner mask surface into a nose portion and a mouth portion, thereby forming a nose chamber and a mouth chamber with separate airflows. The frame insert provides a support structure that is adapted for fastened engagement with the conventional single-chambered mask so that separate isolated chambers are formed about the mouth and nose within the mask covering.

The inventive concepts presented herein are illustrated in a number of different embodiments, each showing one or more concepts, though it should be understood that, in general, the concepts are not mutually exclusive and may be used in combination even when not so illustrated. To further clarify the advantages and features of the present invention, a more particular description of the invention will be rendered by reference to specific embodiments thereof illustrated in the appended figures. Therefore, for a better understanding of these and other aspects of the present invention, reference should be made to the following detailed description taken in conjunction with the accompanying drawings in which like reference numerals and character designate like parts throughout the figures thereof.

### BRIEF DESCRIPTION OF THE DRAWINGS

For a fuller understanding of the nature and objects of the present invention, references in the detailed description set forth below shall be made to the accompanying drawings in which:

FIG. 1(A) and FIG. 1(B) show in alternate views a prior art disposable conventional mask having a single chamber formed upon the face of the wearer;

FIG. 2(A) is a plan view of one preferred embodiment of the frame insert made in accordance with the present invention for transforming a single-chambered mask into a protective dual-chambered mask;

FIG. 2(B) is a perspective view of a modified structural version of the frame insert of FIG. 2(A) incorporating an additional post member upwardly projecting from the forward vertex of the frame insert structure;

FIG. 3 is a plan view of another preferred embodiment of the frame insert made in accordance with the present invention for transforming a single-chambered mask into a protective dual-chambered mask;

FIG. 4 is a plan view of a further preferred embodiment of the frame insert made according to the present invention more suitable for transforming wider single-chambered masks;

FIG. 5(A)-5(C) show in respective views an exemplary assembly of a conventional surgical mask engaged with the frame insert of FIG. 2(A) in accordance with the present invention.

FIG. 6(A)-6(C) show in respective views another exemplary assembly of a typical N95 mask engaged with the frame insert of FIG. 3 in accordance with the present invention.

FIG. 7(A)-7(C) show in respective views a further exemplary assembly of a conventional surgical mask engaged with the frame insert of FIG. 4 in accordance with the present invention; and

FIG. 8(A)-8(C) show in respective views an additional exemplary assembly of another form of N95 mask engaged with the frame insert of FIG. 3 in accordance with the present invention.

Further, skilled artisans will appreciate that elements in the figures are illustrated for simplicity and may not have been necessarily been drawn to scale. Furthermore, in terms of the construction of the device, one or more components of the device may have been represented in the figures by conventional symbols, and the figures may show only those specific details that are pertinent to understanding the embodiments of the present invention so as not to obscure the figures with details that will be readily apparent to those of ordinary skill in the art having the benefit of the description herein.

### DETAILED DESCRIPTION OF THE INVENTION

Described herein are nonlimiting example embodiments of the present invention, which includes a frame insert for a protective face mask and the associated method of its use in making a dual-chambered mask from a variety of conventional single-chambered masks.

The various embodiments including the example embodiments will now be described more fully with reference to the accompanying drawings, in which the various embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, the sizes of components may be exaggerated for clarity.

It will be understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “first edge,” “second edge,” “interstitial spaces” or “slots,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures.

The subject matter of various embodiments, as disclosed herein, is described with specificity to meet statutory requirements. However, the description itself is not intended to limit the scope of this patent. Rather, the inventor has contemplated that the claimed subject matter might also be embodied in other ways, to include different features or combinations of features similar to the ones described in this document, in conjunction with other technologies. Generally, the various embodiments including the example embodiments relate to a frame insert for a protective face mask and its method of use in transforming a conventional single-chambered mask into a dual-chambered mask.

Referring to the drawings, the following is a list of elemental parts and component of the present frame insert and those associated structural elements shown employed in connection with the present invention:
110 prior art single-chambered protective mask;
120 body of single-chambered protective mask;
130 elastic bands;
200 first embodiment of frame insert;
210 first edge;
220 second edge;
225 panel section;
230 base opening;
240 forward vertex;
250 curved strut;
260 periphery tips;
270 notch clips;
280 raised clips;
290 post member;
300 second embodiment of frame insert;
310 first edge;
320 second edge;
325 panel section;
330 base opening;
340 forward vertex;
350 curved strut;
360 periphery tips;
370 interstitial spaces or slots;
380 circular hole;
400 third embodiment of frame insert;
410 first edge;
420 second edge;
430 intermediate edge;
440 panel section;
450 curved strut;
460 peripheral tips;
470 interstitial spaces or slots;
480 base opening;
500 first dual-chambered mask assembly;
510 outer surface of mask covering;
520 inner surface of mask covering;
530 elastic bands;
600 second dual-chambered mask assembly;
610 outer surface of mask covering;
620 inner surface of mask covering;
630 elastic bands;
700 third dual-chambered mask assembly;
710 outer surface of mask covering;
720 inner surface of mask covering;
730 elastic bands;
800 fourth dual-chambered mask assembly;
810 outer surface of mask covering;
820 inner surface of mask covering; and
830 clastic bands.

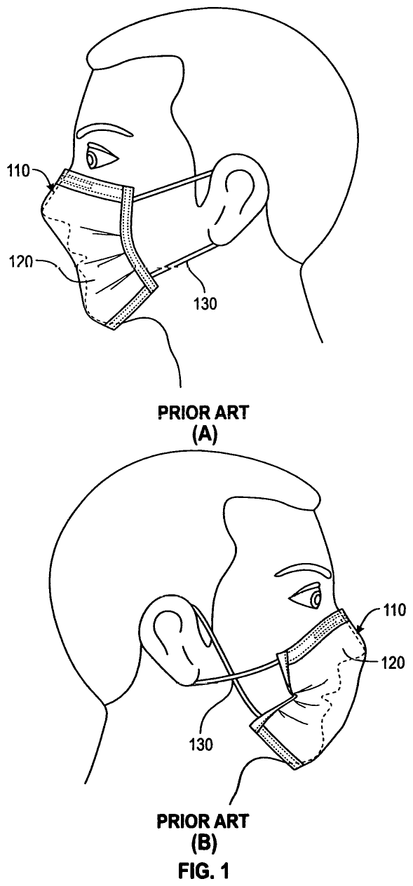

FIG. 1(A) and 1(B) show opposite side views of a prior art disposable protective mask 110, commonly referred to as a surgical mask, having a single breathing chamber formed about the nose and mouth of the wearer. As seen in FIG. 1(A), the mask 110 comprises a body 120 made of a flexible cloth material with one or more pleats running laterally that allow a curved-shaped covering to be formed upon the face of the wearer when the mask is secured with the periphery thereof covering the mouth and nose of the wearer to form a single chamber between the mask and the face of the wearer. Elastic bands 130, attached to the periphery of the mask body 120 in the form of a loop on either side pass around the ear of the wearer of the mask 110 to hold the mask against the face of the wearer. The elastic bands 130 secure the mask 110 to the wearer's face and provide an effective seal between the wearer's face and the periphery of the mask. When the mask 110 is properly secured, the mask body 120 is positioned generally close to the nose and mouth of the wearer and is repeatedly moved to and from the mouth and nose during the inhaling and exhaling of normal breathing by the wearer. It is during this normal breathing process and the exchange of breathed air between the mouth and nose that saliva and breathing vapers will tend to develop and be somewhat contained by the mask body 120 making the wearer uncomfortable. As seen in FIG. 1(B), the elastic bands 130 may be crossed to secure the mask body 120 closer beneath the chin to reduce gaps between the mask body and skin, which closer fit tends to make the wearer uncomfortable especially during extended periods.

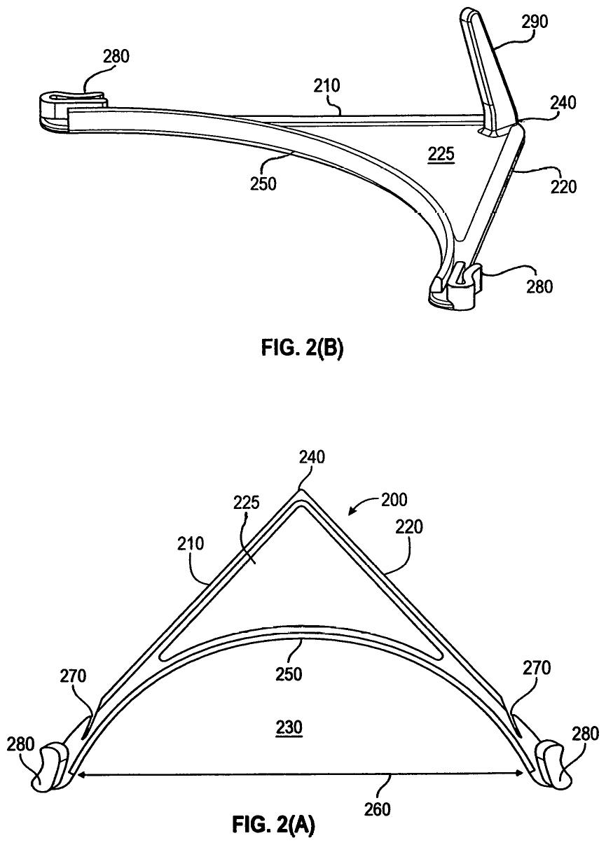

Referring now to FIG. 2(A) and 2(B), a first embodiment of a frame insert 200 is shown formed and constructed in accordance with the present invention. The frame insert 200 is integrally formed in a substantially triangular shape and includes a first edge 210, a second edge 220, a panel section 225 triangular in shape and forwardly disposed therebetween, and a base opening 230 rearward to the panel section. The first edge 210 and the second edge 220 are straight and relatively smooth surfaces for supporting a mask covering thereupon with surfaces of the edges facilitating the flow or drape of the mask covering into the proper supported position. The first edge 210 and the second edge 220 are converged about the panel section 225 to meet at a vertex 240 forwardmost on the frame insert 200. The base opening 230 of the frame insert 200 is arcuate in shape and is established by a curved strut 250 running transversely across the frame insert 200 rearward of panel section 225 along a radius ending at periphery tips 260 rearward most on either side of the frame insert. The curved strut 250 and the periphery tips 260 are integrally connected to either side of the first edge 210 and second edge 220 completing the triangular of the shape of the frame insert 200. The first edge 210 and the second edge 220 each have a notch clip 270 formed along their respective lengths similarly positioned near the periphery tips 260 on opposite sides of the base opening 230, with the notch clip herein formed and located serving to provide a means for fastening the typical surgical mask covering to the frame insert 200 on either side. In addition, a raised clip 280 is formed and positioned rearward of the notch clips 270 on each side of the first edge 210 and second edge 220 at the periphery tips 260 of the base opening 230, with the form and location of the raised clips serving more suitably to engage and fasten the wider spans of the typical N95 on either side of the frame insert 200.

In the illustrated embodiments of the frame insert 200 seen in FIG. 2(A) and 2(B), the notch clips 270 and the raised clips 280 may be of any shape and structure without limiting their functionality for the clipping and fastening of the mask covering with any means (e.g., mask band). In these embodiments, the notch clips 270 and the raised clips 280 are like features positioned to the corresponding length of a specified mask covering such as one position for surgical and one position for N95 mask. These respective clips 270 and 280 of frame insert 200 and their positioned locations are made to be specifically suitable to the different sizes of these standard masks and each similarly function and serve to provide fastened tension at the lateral ends of those respective mask coverings to keep the mask coverings closely engaged to the frame insert.

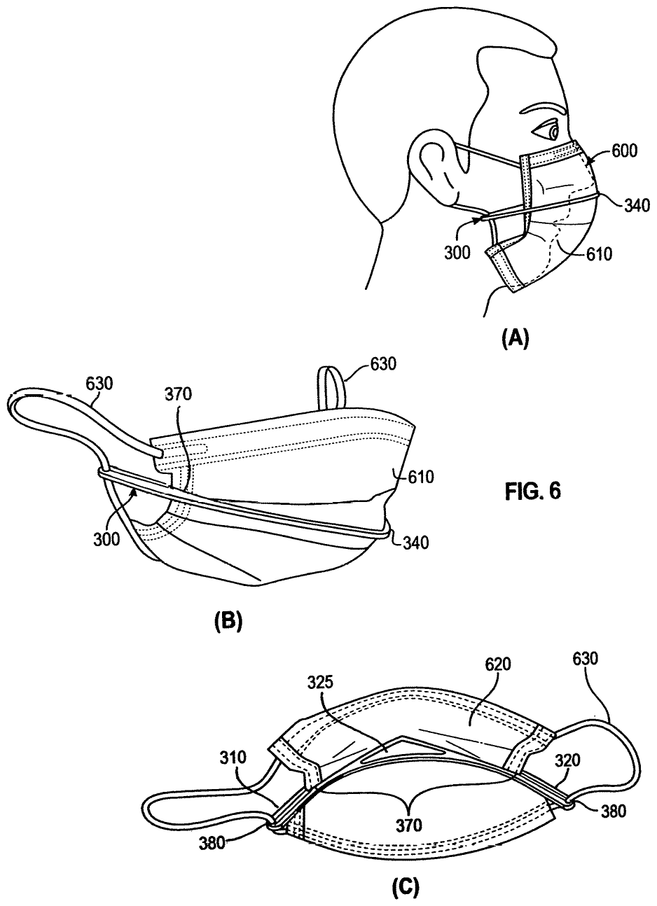

By using the frame insert 200 in assembly with in the conventional single-chambered mask, the frame insert substantially divides the single chamber of the mask into an isolated two-chamber mask for healthier breathing and also eliminates leakage gaps between the mask and the frame insert. In the assembled dual-chambered mask 500, best seen in FIG. 5(A)-5(C), an upper chamber is established allied to the frame insert 200 above panel section 225 and arranged to direct breathing air in a first chamber over the nose of the wearer, while a lower chamber is established allied to the frame insert below the panel section thereof and arranged to direct breathing air over the mouth of the wearer, with the upper and lower chambers being separated and isolated from each other. The frame insert 200 which is in triangle shape pushes the material out away from the skin and mouth for better breathing and talking. The frame insert 200 is suitable for any type of mask including a surgical mask, an N95 mask or a cloth mask of any size. In an example embodiment, the notch clip 270 is positioned generally for facilitating fastening of the surgical mask or the cloth mask, and the raised clip 280 is positioned generally to engage and fasten those prior art conventional mask having a wider lateral covering, such as the N95 masks, with both providing tensioned attachment at the ends of the mask to keep the mask, whatever the type, close to the frame insert.

In a modified structural version of frame insert 200, seen in FIG. 2(B), a post member 290 projecting upwardly from the forward vertex 240 and inclined inwardly at a slight angle is incorporated upon the frame insert to provide an added element of framing for the enhanced formation of the upper chamber over the nose in the assembly with increased volume spacing being created for certain cloth or surgical masks. The post member 290 may be straight in its projected length or slightly curved and may be integrally formed upon the frame insert 200 or made separately to be inserted and connected in place. It should be noted here and understood that the present frame insert 200 and those further embodiments described below are made of plastic or plastic-like material sufficiently rigid and durable in structure to maintain their preferred forms for assembled usage and further provide flexibility and smoothness of surfaces, particularly those that may come into skin contact with the wearer of the assembled masks.

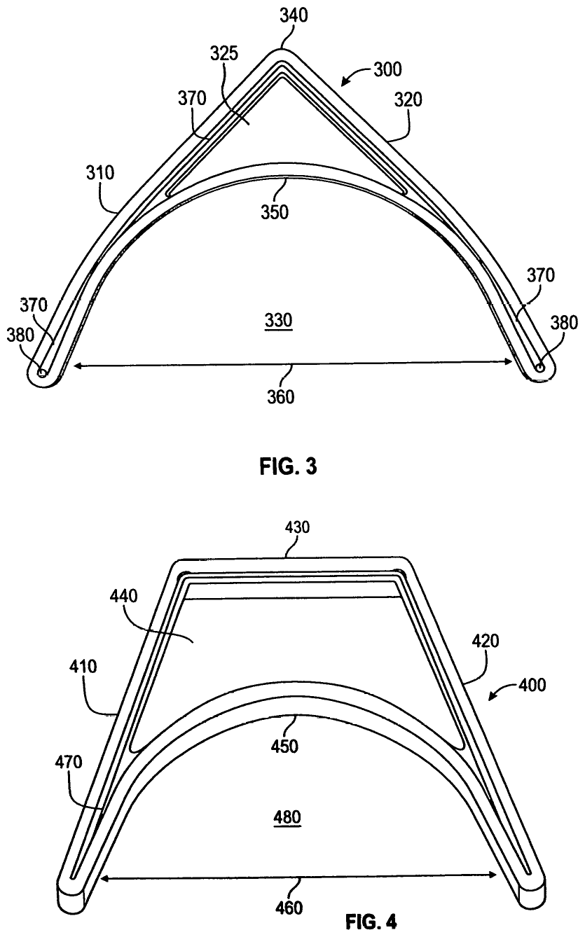

Referring now to FIG. 3, a second frame insert embodiment 300 made in accordance with the present invention is integrally formed in a triangular-like shape, like that of frame insert 200, and includes a first edge 310, a second edge 320, a panel section 325 triangular in shape and forwardly disposed therebetween, and a base opening 330 rearward to the panel section. The first edge 310 and the second edge 320 are converged about the panel section 325 to meet at a vertex 340 forwardmost on the frame insert 300. The first edge 310 and the second edge 320 include an interstitial space or slot 370 in a width substantially uniform running through the length of each edge. The first edge 310 and the second edge 320 are slightly curved or bowed along their respective lengths to allow a soft fabric mask to better drape and follow the edges surfaces upon assembly. The first edge 310 and the second edge 320 are converged to meet at a vertex 340 forwardmost on the frame insert 300. The base opening 330 of the frame insert 300 is arcuate in shape having separate periphery tips 360 on either side, like that of frame insert 200, and is established by a curved strut 350 running transversely across the frame insert 300 along a radius ending at the rearward most ends of the first and second edges 310 and 320 at the periphery tips on either side of the base opening to complete the triangular shape of the frame insert 300.

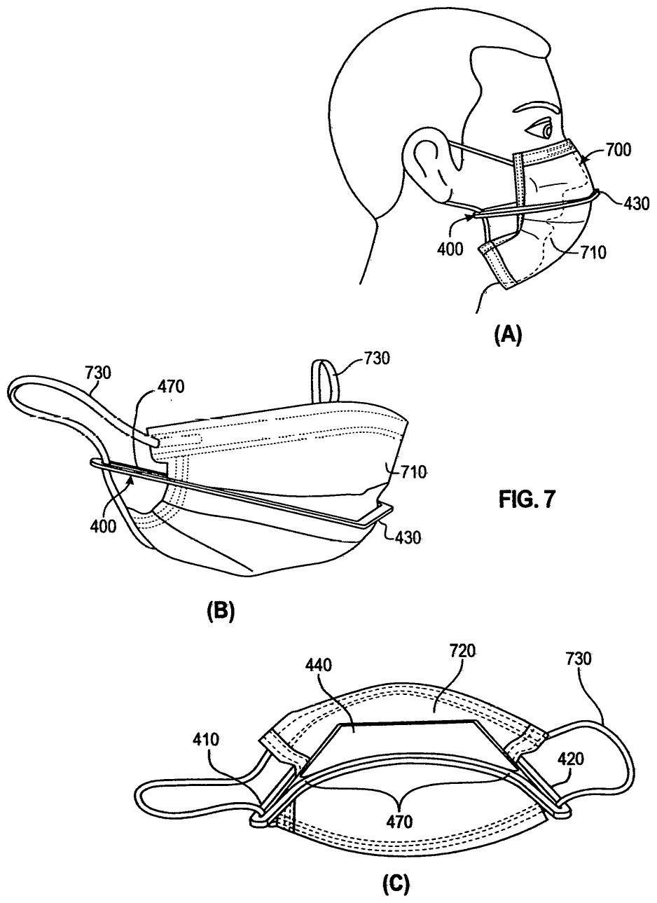

The slot width of the interstitial space 370 along and through the respective first and second edges 310 and 320 of the frame insert 300 allow the mask to slide down and through the frame insert across and through the forward vertex 340 and rearward through the first and second edges and facilitate the adjustment and fit of the selected mask in the frame insert. The slot width of the interstitial space 370 may be varied throughout the frame insert 300. For example, the width thickness of the interstitial space 370 at the forward vertex may be increased over the interstitial space running through the first and second edges 310, 320 in order to accommodate the relative thickness of seams typically found centrally located in those masks and will result in a better and more easily adjusted fit of the conventional masks through the entire frame insert 300. Further, the width thickness of the interstitial space 370 may be increased at the rearward ends of the first and second edges 310 and 320 provided with a circular hole 380 to provide a more suitable engagement and fit for seating the elastic bands of the assembled mask as seen in FIG. 6(A)-6(C).

When the frame insert 300 is used in assembly, the interstitial space 370 which is positioned along the perimeter of the frame insert and through the first edge 310 and the second edge 320 allows the mask to slide down and through the frame insert across and through the forward vertex 340 and through the first and second edges on each side. By using the frame insert 300 in assembly with in the conventional single-chambered mask, the frame insert substantially divides the single chamber of the mask into an isolated two-chamber mask for healthier breathing and also eliminates leakage gaps between the mask and the frame insert. In the assembled dual-chambered mask 500, as seen in FIG. 6(A)-6(C), an upper chamber is established allied to the frame insert 300 above panel section 325 and arranged to direct breathing air in a first chamber over the nose of the wearer, while a lower chamber is established allied to the frame insert above the panel section thereof and arranged to direct breathing air over the mouth of the wearer, with the upper and lower chambers being separated and isolated from each other. The frame insert 300 which is in triangle shape pushes the material out away from the skin and mouth for better breathing and talking.

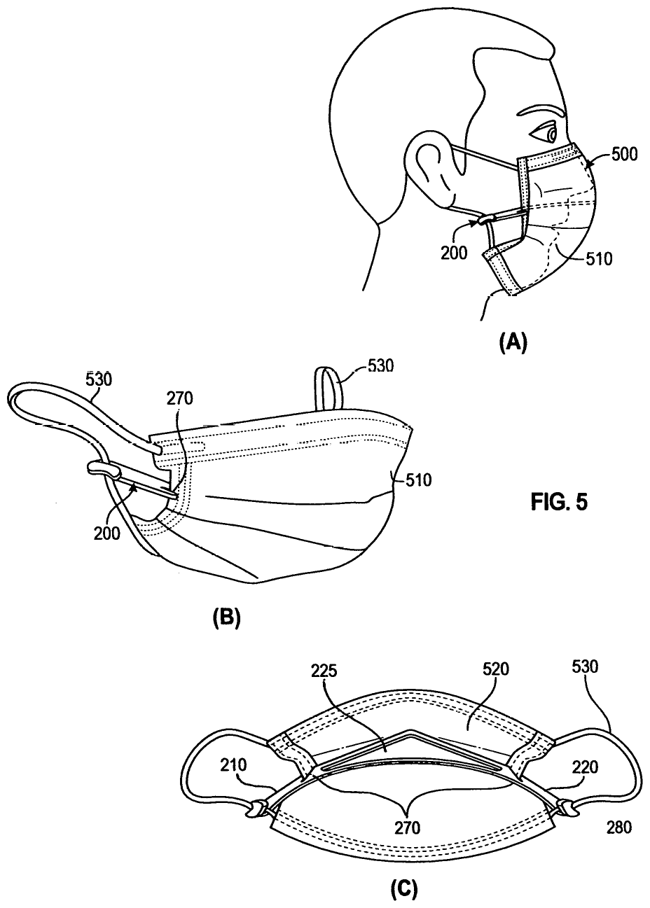

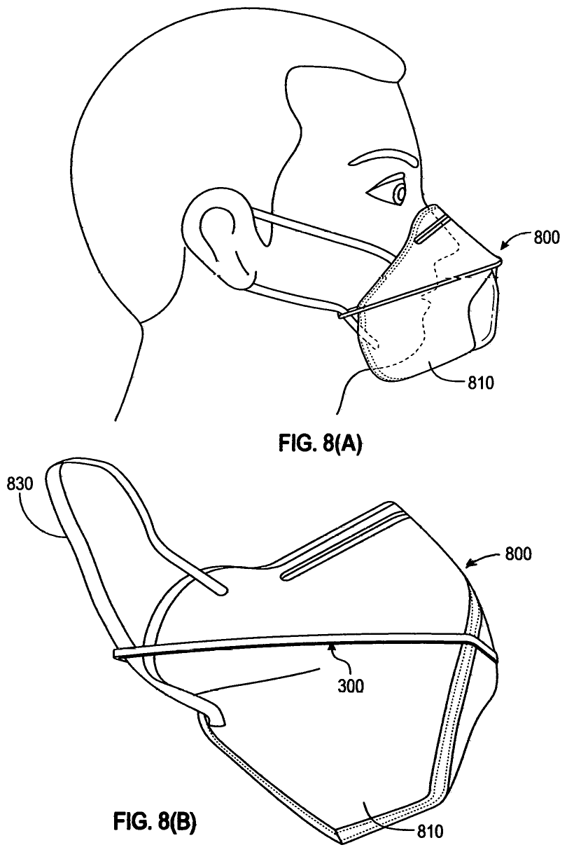

Referring now to FIG. 4, a third embodiment of the frame insert, generally indicated 400, is integrally formed in a trapezoidal shape and includes a first edge 410 and second edge 420 running along opposite sides with an intermediate edge 430 disposed therebetween on the forwardmost perimeter, with all of edges being interconnected about a panel section 440 substantially trapezoidal in form at the front on the frame insert. This trapezoidal configuration of frame insert 400, different from that of the triangular form of the embodiment of frame insert 300, provides a wider forward surface more compatible with broader width masks such as that of the N95. Frame insert 400 further includes a curved strut 450 bordering the rear of panel section 440 and running transversely across the frame insert along a radius ending at periphery tips 460 on either side at the rearward most ends of the respective first and second edges 410 and 420. The course and extension of the curved strut 440 provides the frame insert 400 with an arcuate base opening 480 intended to fit and conform with the middle region of the face between the nose and the mouth so that the frame insert and particularly the panel section 440 thereof will separate and isolate the regions above and below when the frame insert is assembled to the single-chambered mask as shown in FIG. 7(A)-7(C). In this embodiment of frame insert 400, interstitial spaces 470 or slots are formed along the entire perimeter lengths of the first edge 410, second edge 420 and intermediate edge 430, about the forward perimeter of panel section 440 and extending to the periphery tips 460 to allow a full engagement of the conventional mask properly positioned within the frame insert when assembled in combination.

It should be noted and understood that the form of the present frame insert should not be restricted to the specific types shown, and that the present inventive frame insert may take such other shapes and structural configurations capable of dividing a single chamber mask into an isolated two-chamber mask when the frame insert is engaged in a combined assembly with a conventional single-chambered mask.

Referring now to FIG. 5(A)-5(C), a first mask assembly 500 made in accordance with the present invention comprises an assembled combination of present frame insert 200, as seen in FIG. 2(A), in fastened engagement with a conventional single-chambered surgical mask, such as that seen in FIG. 1(A). In the mask assembly 500, the outer covering 510 of the assembled mask is positioned to cover the face of the wearer from just beneath the eyes to the area of the chin, held in such place in typical fashion with elastic bands 530 looped around the ears of the wearer. In combining the frame insert 200 in engaged assembly with the conventional single-chambered mask, the frame insert fastens to the side edges of the mask via the notch clips 270 on both sides and in so doing, substantially divides the inner covering 520 of the assembled mask into two separate and isolated chambers, an upper chamber above panel section 225 to direct breathing air in a first chamber over the nose of the wearer, and a lower chamber below the panel section to direct breathing air over the mouth of the wearer. The frame insert 200 with its triangular shape further pushes the mask covering out away from the skin and mouth for better breathing and talking. The isolated formation of a nose chamber and a mouth chamber with separate airflows for breathing is further benefitted by the tensioned engagement of the mask within the notch clips 270 on both sides of frame insert 200 that serve to eliminate leakage gaps between the inner covering 520 of the assembled mask 500 and the engaged frame insert 200.

Referring now to FIG. 6(A)-6(C), a second mask assembly 600 made in accordance with the present invention comprises an assembled combination of present frame insert 300, as seen in FIG. 3, in fastened engagement with a conventional single-chambered surgical mask, such as that seen in FIG. 1(A). In the mask assembly 600, the outer covering 610 of the assembled mask is positioned to cover the face of the wearer from just beneath the eyes to the area of the chin, held in such place in typical fashion with elastic bands 630 looped around the ears of the wearer. In combining the frame insert 300 in engaged assembly with the conventional single-chambered mask, the interstitial space or slot 370 formed along the perimeter and through the first edge 310 and the second edge 320 of the frame insert allows the mask to slide down and through the frame insert across and through the forward vertex 340 and through the first and second edges on each side. In doing so, the frame insert 300 substantially divides the inner covering 620 of the assembled mask into two separate and isolated chambers, an upper chamber above panel section 325 to direct breathing air in a first chamber over the nose of the wearer, and a lower chamber below the panel section to direct breathing air over the mouth of the wearer. The frame insert 300 with its triangular shape further pushes the mask covering out away from the skin and mouth for better breathing and talking. The isolated formation of a nose chamber and a mouth chamber with separate airflows for breathing is further benefitted by the tensioned engagement of the mask using the interstitial spaces or slots 370 along the perimeter of frame insert 300 that serves to eliminate leakage gaps between the inner covering 620 of the assembled mask 600 and the engaged frame insert 300.

Now referring to FIG. 7(A)-7(C), a third mask assembly 700 made in accordance with the present invention comprises an assembled combination of present frame insert 400, as seen in FIG. 4, in fastened engagement with a conventional single-chambered cloth or N95 mask. In the mask assembly 700, the outer covering 710 of the assembled mask is positioned to cover the face of the wearer from just beneath the eyes to the area of the chin, held in such place in typical fashion with elastic bands 730 looped around the ears of the wearer. In combining the frame insert 400 in engaged assembly with the conventional cloth or N95 mask, the interstitial spaces or slots 470 formed along the perimeter and through the first edge 410, second edge 420 and intermediate edge 430 of the frame insert allows the mask body to slide down and through the frame insert across and through the intermediate edge 430. In doing so, the frame insert 400 substantially divides the inner covering 720 of the assembled mask 700 into two separate and isolated chambers, an upper chamber above panel section 440 to direct breathing air in a first chamber over the nose of the wearer, and a lower chamber below the panel section to direct breathing air over the mouth of the wearer. The frame insert 400 with its prominent trapezoidal shape further pushes the mask covering out away from the skin and mouth for better breathing and talking. The isolated formation of a nose chamber and a mouth chamber with separate airflows for breathing is further benefitted by the tensioned engagement of the mask within the interstitial spaces or slots 470 along the perimeter of frame insert 400 that serves to eliminate leakage gaps between the inner covering 720 of the assembled mask 700 and the engaged frame insert 400.

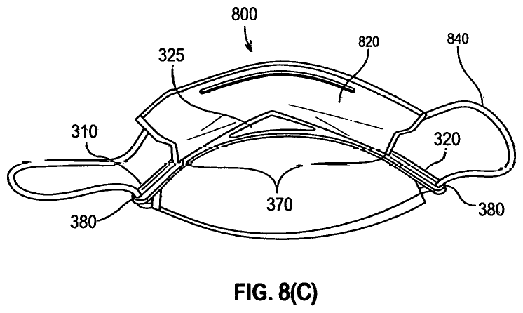

In FIG. 8(A)-8(C), a fourth mask assembly 800 made in accordance with the present invention comprises an assembled combination of the frame insert 300, as seen in FIG. 3, in fastened engagement with another conventional type of single-chambered N95 mask. In mask assembly 800, the outer covering 810 of the assembled mask is positioned to cover the face of the wearer from just beneath the eyes to the area of the chin, held in such place in typical fashion with elastic bands 830 looped around the ears of the wearer. In using frame insert 300 in engaged assembly with the conventional N95 mask, the interstitial spaces or slots 370 formed along the perimeter and through the first edge 310, second edge 320 and forward vertex 340 allows the mask body to slide down and through the frame insert into proper position. In doing so, the frame insert 300 substantially divides the inner covering 820 of the assembled mask 800 into two separate and isolated chambers, an upper chamber above panel section 325 to direct breathing air in a first chamber over the nose of the wearer, and a lower chamber below the panel section to direct breathing air over the mouth of the wearer. The frame insert 300 with its prominent tirangular3 shape further pushes the mask covering out away from the skin and mouth for better breathing and talking. The isolated formation of a nose chamber and a mouth chamber with separate airflows for breathing is further benefitted by the tensioned engagement of the mask within the interstitial spaces or slots 370 along the perimeter of frame insert 300 that serves to eliminate leakage gaps between the inner covering 820 of the assembled mask 800 and the engaged frame insert 300.

Therefore, it is apparent that the described invention provides an improved method of making a dual-chambered protective face mask having separate and isolated breathing chambers formed about the nose and mouth of the wearer for greater comfort and healthier breathing during prolonged periods of usage. More particularly, the present invention provides a frame insert member that serves as a supporting attachment in combination with a conventional single chamber protective face mask that will transform the single chamber face mask to a dual-chambered mask with separate and isolated breathing chambers over the nose and mouth of the wearer without leakage gaps therebetween and provide an effective barrier against air pollutants and germs while enabling the wearer to better breathe clean air during prolonged periods of usage. In addition, the described invention provides a universal support frame that may be releasably attached to the mask body of a variety of different available types and sizes of single chamber protective face masks in each instance producing a dual-chambered protective face mask with separate isolated chambers established over the nose and mouth of the wearer for better comfort and breathing while worn. The described invention also provides a specially formed and configured support frame that when assembled in engagement with any type or size of available single chamber protective face mask will provide a secure and comfortable dual-chambered mask for protection of the wearer with healthier directional air flow during the normal process of breathing. The foregoing embodiments of the described frame insert and their support attachment with the conventional single-chambered face mask further provides a comfortable and effective dual-chambered protective face mask that is readily assembled, easy to adjust, and capable of being worn for extended durations.

Obviously, other embodiments and modifications of the present invention will readily come to those of ordinary skill in the art having the benefit of the teachings presented in the foregoing description and drawings. Alternate embodiments of different shapes and sizes, as well as substitution of known materials or those materials which may be developed at a future time to perform the same function as the present described embodiment are therefore considered to be part of the present invention. Furthermore, certain modifications to the described embodiment that serve to benefit its usage are within the scope of the present invention. Accordingly, it is understood that this invention is not limited to the particular embodiment described, but rather is intended to cover modifications within the spirit and scope of the present invention including the appended claims.

What is claimed is:

1. A frame insert for transforming a single-chambered protective face mask into a dual-chambered mask, comprising:
a support member integrally formed having a first edge, a second edge and a base strut connected together along the periphery of said support member with a panel section therebetween, the first edge and the second edge converging at one end to meet at a vertex forward on said support member and the base strut formed in a curved configuration between opposite ends of the first edge and second edge to provide an arcuate base opening opposite to the vertex; and
clip means connected to the support member at either end of the first and the second edge on opposite sides of the base opening to fasten the single-chambered face mask to the support member in an engaged mask assembly, whereby the support member in the engaged mask assembly substantially divides the single chamber of the mask into an isolated two-chamber mask for healthier breathing and also eliminates leakage gaps between the mask and the frame insert.

2. The frame insert of claim 1, wherein the support member engaged in the mask assembly divides the single-chambered mask into a first chamber above the panel section to isolate breathing air over the nose of the wearer and a second chamber below the panel section to isolate breathing air over the mouth of the wearer, with the first and second chambers being separated and isolated from each other.

3. The frame insert of claim 1, wherein the support member is triangular in shape.

4. The frame insert of claim 1, wherein the support member engaged in the mask assembly pushes the mask out away from the skin and mouth for better breathing and talking.

5. The frame insert of claim 1, wherein the support member further comprises a post member projecting upwardly from the forward vertex and inclined inwardly to provide framing for the enhanced formation of the first chamber over the nose in the engaged mask assembly.

6. A frame insert for transforming a single-chambered mask into a protective dual-chambered mask, comprising:
a support member integrally formed having a first edge, a second edge and a curved strut connected together along the periphery of said support member, and a panel section disposed therebetween, the first edge and the second edge converging forwardly about the panel section at a vertex at the front of support member and the curved strut extending transversely between separate ends of the first edge and second edge to provide an arcuate base opening opposite to the vertex, the first edge and the second edge further formed having an interstitial space along their respective lengths to fasten the support member to the single-chambered mask in an engaged mask assembly, whereby the support member in the engaged mask assembly substantially divides the single chamber of the mask into an isolated two-chamber mask for healthier breathing and also eliminates leakage gaps between the mask and the frame insert.

7. The frame insert of claim 6, wherein the panel section of the support member is triangular in shape.

8. The frame insert of claim 6, wherein the first edge and the second edge are curved or bowed.

9. The frame insert of claim 6, wherein the vertex is positioned over philtrum in the engaged mask assembly while the first edge and the second edge provide side walls to the arcuate base opening.

10. A frame insert for transforming a single-chambered mask into a protective dual-chambered mask, comprising:
a support member integrally formed having a first edge, a second edge, an intermediate edge connected between the first and second edges, a curved strut connected along the periphery of said support member, and a panel section disposed therebetween, the intermediate edge being disposed forwardly on the support member and the curved strut extending transversely between separate ends of the first edge and second edge to provide an arcuate base opening opposite to the intermediate edge, all of said edges being further formed having an interstitial space along their respective lengths to fasten the support member to the single-chambered mask in an engaged mask assembly, whereby the support member in the engaged mask assembly substantially divides the single chamber of the mask into an isolated two-chamber mask for healthier breathing and also eliminates leakage gaps between the mask and the frame insert.

11. The frame insert of claim 10, wherein the panel section of the support member is trapezoidal in shape.

12. The frame insert of claim 10, wherein the intermediate edge is positioned over philtrum in the engaged mask assembly while the first edge and the second edge provide side walls to the arcuate base opening.

13. A mask assembly comprising:
a mask body having an outer surface and an inner surface covering at least the nose and mouth, a pair of ear loops disposed on the mask body; and
a frame insert configured to act as a separation means which is substantially dividing said inner surface into a nose portion and a mouth portion, thereby, forming a nose chamber and a mouth chamber with separate airflows, the frame insert includes a curved strut and a periphery part which is separated from the mouth and nose by an appropriate distance and the mask is covered on the outside.

14. The mask assembly of claim 13, wherein the frame insert is of a triangular shape.

15. The mask assembly of claim 13, wherein the frame insert is of a trapezoidal shape.
